(19) United States
(12) Patent Application Publication
(10) Pub. No.: US 2020/0347973 A1
(43) Pub. Date: Nov. 5, 2020

(54) HOSE CONNECTOR

(71) Applicant: WEN SHENG FU CO., LTD, Lu Kang Township (TW)

(72) Inventor: Hung-Lin Lai, Lu Kang Township (TW)

(21) Appl. No.: 16/401,259

(22) Filed: May 2, 2019

(51) Int. Cl. F16L 33/22

(52) U.S. Cl. CPC F16L 33/223

(57) ABSTRACT

A hose connector has: a head portion, at least one connecting bolt, and a tightening ring. The head portion has a flow channel with at least two open ends, and at least one of the open ends is provided with a threaded portion. The connecting bolt has an inner threaded section engaging the threaded portion of the open end of the head portion, an opening of the connecting bolt has a stopping portion. The tightening ring has a groove configured to accept the stopping portion, a clasping end is formed adjacent to an outer edge of the groove and engaging an outer wall of the stopping portion, a convex ring is formed at another end of the tightening ring and pushing against the stopping portion.

### BACKGROUND OF INVENTION

### Field of Invention

The present invention relates to a hose connector, and more particularly to an improved hose connector.

### Description of the Related Art

A conventional hose connector structure, please refer to FIGS. 7 and 8, includes: a head portion 50 and at least one the connecting bolt 60 disposed at an open end 51 of disposed at the head portion 50. The head portion 50 has a flow channel connected to at least two open ends 51, and the open end 51 is provided with the threaded portion 52. The connecting bolt 60 is provided with an inner threaded section 61 screwed to the open end 51 of the head portion 50, and an open end of the connecting bolt 60 is retracted to form a stopping portion 62 accepting a tightening ring 70. The tightening ring 70 is additionally accommodated in inside of the connecting bolt 60 and only limited by the stopping portion 62 at one end. The connecting bolt 60 is screwed to the open end 51 of the head portion 50, thereby the tightening ring 70 is limited between the head portion 50 and the connecting bolt 60, which provides a connection between a hose and the hose connector after the hose is inserted.

It is not difficult to find out that the above-mentioned conventional structure has some shortcomings. The main reason is as follows: The outer circumference of the tightening ring 70 is a convex arc-shaped outer wall, which does not provide any positioning effect for the hose assembly, so that the tightening ring 70 is easily detached from the connecting bolt 60 causing inconvenient to install. In addition, the installation time and labor costs are increased.

Therefore, it is desirable to provide a hose connector to mitigate and/or obviate the aforementioned problems.

### SUMMARY OF THE INVENTION

An objective of present invention is to provide a hose connector, which is capable of improving the above-mention problems.

In order to achieve the above mentioned objective, a hose connector has: a head portion, at least one connecting bolt, and a tightening ring. The head portion has a flow channel with at least two open ends, and at least one of the open ends is provided with a threaded portion. The connecting bolt has an inner threaded section engaging the threaded portion of the open end of the head portion, an opening of the connecting bolt has a stopping portion. The tightening ring has a groove configured to accept the stopping portion, a clasping end is formed adjacent to an outer edge of the groove and engaging an outer wall of the stopping portion, a convex ring is formed at another end of the tightening ring and pushing against the stopping portion.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view of the preferred embodiment according to the present invention.

FIG. 3 is an exploded view of the connecting bolt and the tightening ring of the preferred embodiment according to the present invention.

FIG. 4 is a cross-sectional view and a partial enlarged view of the combination of the preferred embodiment according to the present invention.

FIG. 5 is the state of the actual assembly and use and the partial enlargement diagram of the preferred embodiment according to the present invention.

FIG. 6 is a schematic drawing of another embodiment of the present invention.

FIG. 7 is an exploded view of the prior art.

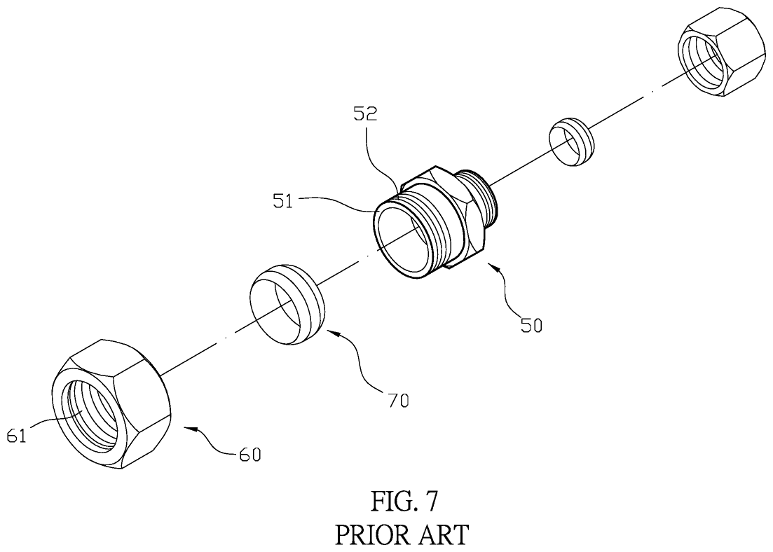

FIG. 8 is a cross-sectional view of the prior art.

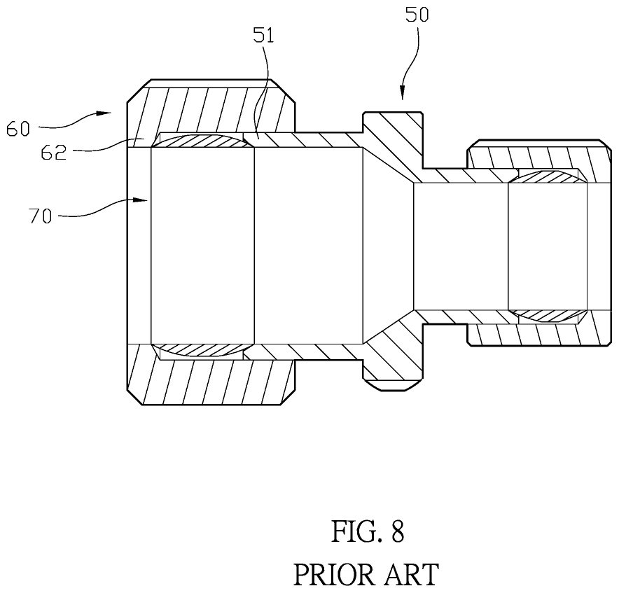

### DETAILED DESCRIPTION OF THE PREFERRED EMBODIMENT

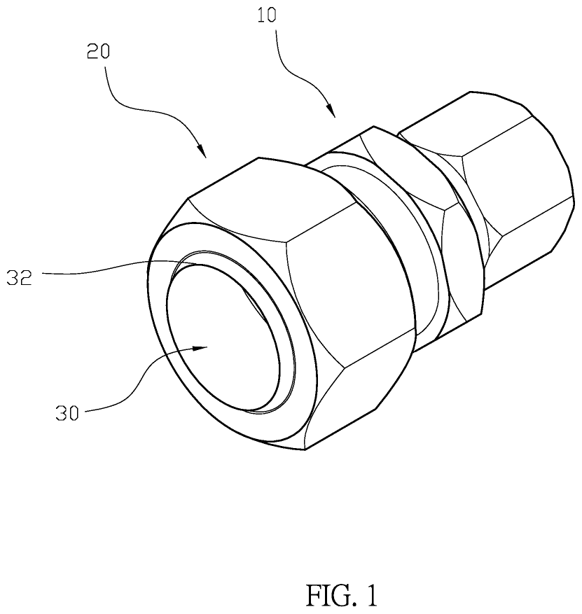

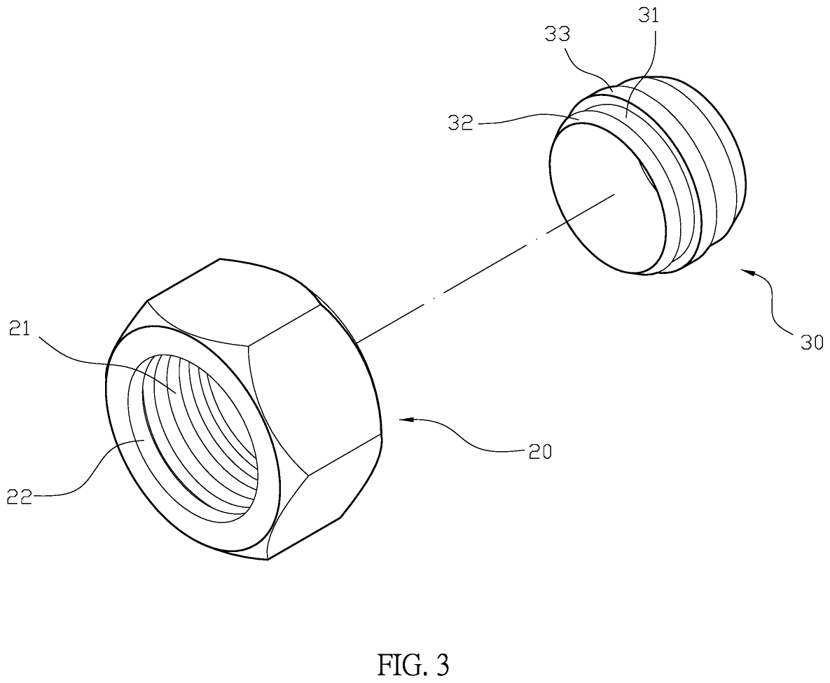

Please refer to FIGS. 1-4. A hose connector a head portion 10, at least one connecting bolt 20 and at least one tightening ring 30. The head portion 10 has a flow channel 11 with at least two open ends 12, and the open end 12 is provided with a threaded portion 13. The open end 12 of the head portion further has a chamfer 121 adjacent to the flow channel 11. The connecting bolt 20 comprises an inner threaded section 21 engaging the threaded portion 13 of the open end 12 of the head portion 10, and an opening of the connecting bolt 20 comprises a stopping portion 22 engaging with the tightening ring 30. The tightening ring 30 has a groove 31 configured to accept the stopping portion 22, a clasping end 32 formed adjacent to an outer edge of the groove 31 and engaging an outer wall of the stopping portion 22, and a convex ring 33 formed at another end of the tightening ring 30 and pushing against the stopping portion 22. Furthermore, another end of the tightening ring 30 facing the flow channel 11 of the head portion 10 is provided with a tapered surface 34 providing a smaller outer diameter and a gap 35 from the connecting bolt 20. An inner diameter of the tightening ring 30 is equal to a diameter of the flow channel 11 of the head portion 10.

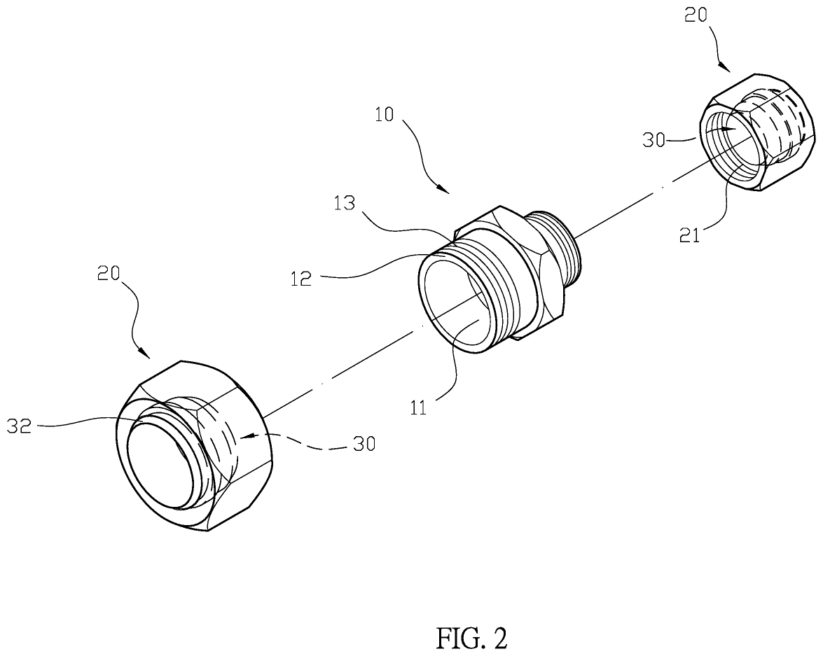

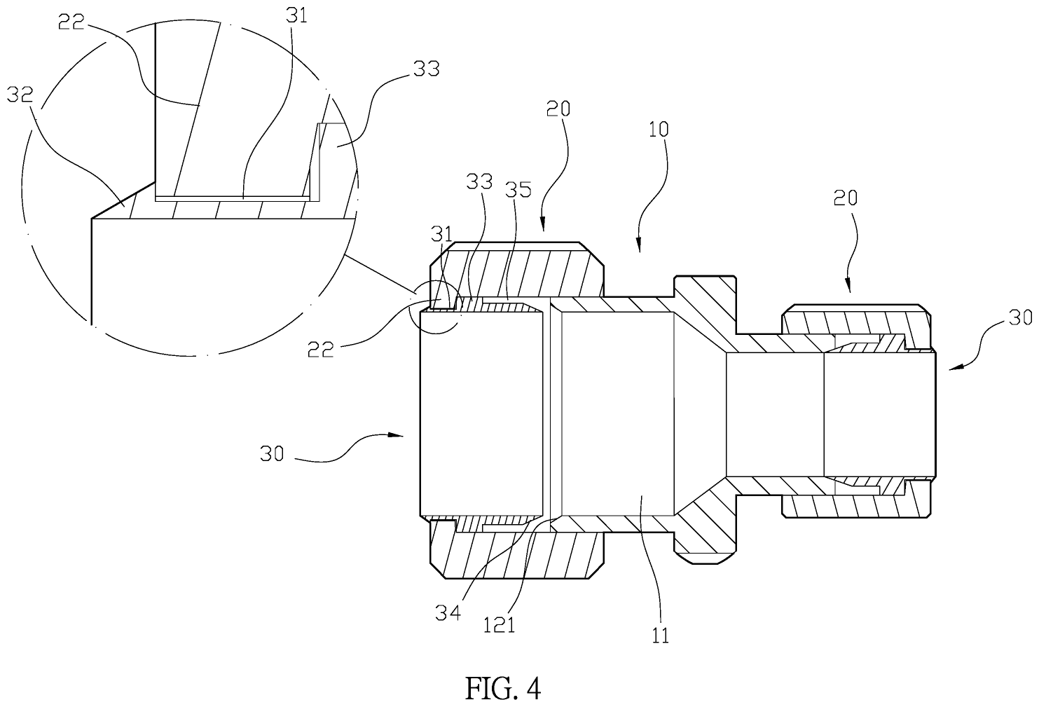

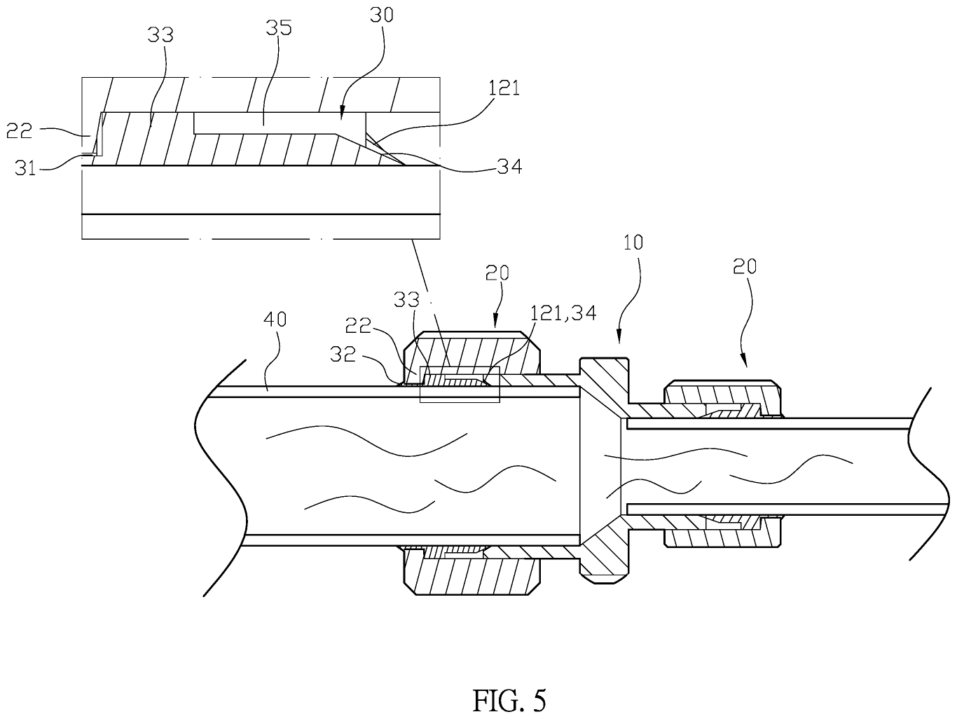

For the assembly of the structure and the state of actual use, please refer to FIG. 2, FIG. 4 and FIG. 5. The inner diameter of the connecting bolt 20 is configured for accepting the tightening ring 30, and coupled to the open end 12 of the head portion 10. The groove 31 of the tightening ring 30 is compatible with the stopping portion 22 of the connecting bolt 20, and the tightening ring 30 is attached to the outer wall of the stopping portion 22 of the connecting bolt 20 by the clasping end 32. Meanwhile, the convex ring 33 pushes against the stopping portion 22, thereby positioning the tightening ring 30 in the connecting bolt 20, and the groove 31 makes no contact with the connecting bolt 20. Finally, the connecting bolt 20 is screwed on to the open end 12 of the head portion 10 to provide a connection for a hose 40.

In summary, when the structure is actually used, the hose 40 is inserted from the connecting bolt 20 and enters through the tightening ring 30 into the flow channel 11 of the head portion 10. After the hose 40 is tightly fitted through the tightening ring 30, and the connecting bolt 20 is locked with the head portion 10. Since the tightening ring 30 is accommodated in the connecting bolt 20 without inferring contact, the hose 40 and the connecting bolt 20 are prevented from forming a synchronized rotation state. While the connecting bolt 20 is locked it also pushed the tightening ring 30 toward the open end 12, and then gradually introduces the tapered surface 34 closer to the chamfer 121 of the open end 12. Therefore, the tightening ring 30 and the open end 12 of the head portion 10 are positioned, and the tightening effect between the head portion 10 and the connecting bolt 20 is achieved through the tightening ring 30, which completes the assembly.

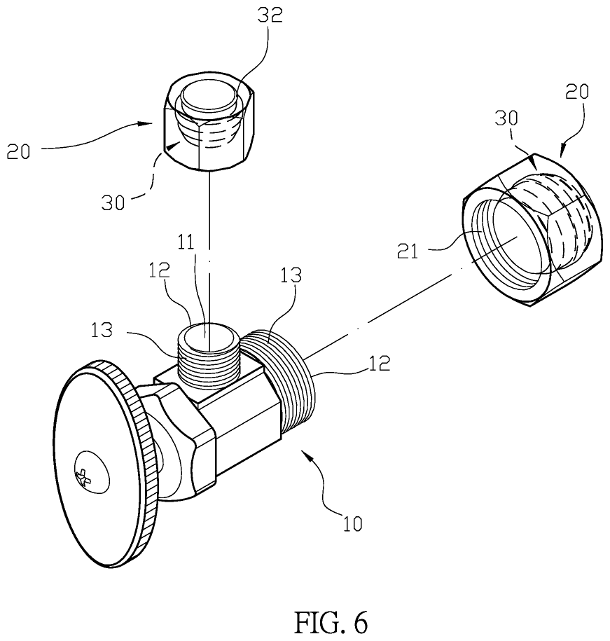

According to another embodiment of the structure, as shown in FIG. 6, the head portion 10 can be a switching valve, the flow channel 11 is L-shaped and a switching handle 14 is also provided.

With the structure of the above-described embodiment, the following benefits can be obtained: the groove 31 of the tightening ring 30 accepts the stopping portion 22 of the connecting bolt 20, and the clasping end 32 engages with the stopping portion 22 at the outer wall while positioning the convex ring 33 against the stopping portion 22. Therefore, the tightening ring 30 is fixed onto the connecting bolt 20 to avoid the tightening ring 30 from falling off the connecting bolt 20 and increases the convenience of the assembling work for the tubular body 40. In addition, the tightening ring 30 forms an no-contact state through the groove 31 and the connecting bolt 20, so that the hose 40 does not rotate with the connecting bolt 20, which greatly increases the installation speed and reduces the labor cost.

Although the present invention has been explained in relation to its preferred embodiment, it is to be understood that many other possible modifications and variations can be made without departing from the spirit and scope of invention as hereinafter claimed.

What is claimed is:

1. A hose connector comprising:
a head portion having a flow channel with at least two open ends, and at least one of the open ends provided with a threaded portion;
at least one connecting bolt comprising an inner threaded section engaging the threaded portion of the open end of the head portion, an opening of the connecting bolt comprising a stopping portion; and
a tightening ring having a groove configured to accept the stopping portion, a clasping end formed adjacent to an outer edge of the groove and engaging an outer wall of the stopping portion, a convex ring formed at another end of the tightening ring and pushing against the stopping portion.

2. The hose connector as claimed in claim 1, wherein the at least one of the open ends of the head portion further has a chamfer adjacent to the flow channel.

3. The hose connector as claimed in claim 1, wherein one end of the tightening ring facing the flow channel of the head portion further comprises a tapered surface providing a smaller outer diameter and a gap from the connecting bolt.

4. The hose connector as claimed in claim 2, wherein one end of the tightening ring facing the flow channel of the head portion further comprises a tapered surface providing a smaller outer diameter and a gap from the connecting bolt.

5. The hose connector as claimed in claim 1, wherein an inner diameter of the tightening ring is equal to a diameter of the flow channel of the head portion.

6. The hose connector as claimed in claim 1, wherein the head portion is a switch valve configured to be controlled manually.
